(19) United States
(12) Patent Application Publication
(10) Pub. No.: US 2026/0054852 A1
(43) Pub. Date: Feb. 26, 2026

(54) Airfield Lighting System

(71) Applicant: Hughey & Phillips, LLC, Urbana, OH (US)

(72) Inventors: Kenneth R. Wagner, Coral Springs, FL (US); Sergio Bastiani, Urbana, OH (US)

(21) Appl. No.: 18/992,417

(22) PCT Filed: Jul. 13, 2023
(86) PCT No.: PCT/US2023/027585

§ 371 Date: Jan. 8, 2025

Related U.S. Application Data
(60) Provisional application No. 63/389,547, filed on Jul. 15, 2022.

(51) Int. Cl. B64F 1/18; F21V 21/30; F21V 23/00

(52) U.S. Cl. CPC B64F 1/18; F21V 21/30; F21V 23/003

(57) ABSTRACT

An airfield lighting system includes an approach lighting subsystem and a runway lighting subsystem. A power supply/controller is configured to provide electrical power to the approach lighting subsystem and the runway lighting subsystem. The power supply/controller is further configured to control operation of the approach lighting subsystem and the runway lighting subsystem. A set of electrical wiring connects the approach lighting subsystem and the runway lighting subsystem to the power supply/controller. The power supply/controller communicates with the approach lighting subsystem and the runway lighting subsystem through the electrical wiring.

### CROSS-REFERENCE TO RELATED APPLICATION

This application claims priority to and incorporates by reference the content of U.S. Provisional Pat. App. No. 63/389,547, filed Jul. 15, 2022.

### FIELD

The present invention relates generally to lighting systems for airfields, in particular to an airfield lighting system for use in conjunction with visible, overt and covert aircraft operations.

### BACKGROUND

Airfield lighting systems serve several purposes. For example, taxi lights are used to guide aircraft along taxiways and tarmacs during periods of low visibility, such as at night or during inclement weather. In addition, runway edge and end lights are used to define the sides and ends respectively of a runway. Approach lighting provides visual guidance information, such as glideslope, to the flight crew of an approaching aircraft.

Although existing airfield lighting systems provide the aforementioned purposes, they are complex and time-consuming to install. The various lights must be permanently mounted, then an electrical wiring system is installed and buried. In fact, installing airfield lighting systems is a significant portion of the work done to construct a runway and taxiway at an airport. Existing airfield lighting systems are thus not practical for use for temporary airfields, such as for remote locations and short-term-use landing zones erected by the military in support of tactical operations. There is a need for an airfield lighting system that can be quickly and easily erected for use and then quickly and easily disassembled once the airfield lighting system is no longer needed.

### SUMMARY

The present invention is a complete visible/overt/covert Night Vision Device (NVD) compatible airfield lighting system. The light emitters of the system preferably comprise light emitting diodes (LEDs), which are robust and consume less power than conventional light sources such as incandescent lamps. However, any suitable light source now known or later invented is within the scope of the invention.

The entire system may be portable and disposable, depending upon the timeline of a mission (such as a military mission) making use of the system. Interconnecting power and control cables extend between elements of the system and are placed above-ground for expediency during setup or teardown of the system.

In one embodiment of the present invention an airfield lighting system comprises an approach lighting subsystem and a runway lighting subsystem. A power supply/controller is configured to provide electrical power to the approach lighting subsystem and the runway lighting subsystem. The power supply/controller is further configured to control operation of the approach lighting subsystem and the runway lighting subsystem. A set of electrical wiring connects the approach lighting subsystem and the runway lighting subsystem to the power supply/controller. The power supply/controller communicates with the approach lighting subsystem and the runway lighting subsystem through the electrical wiring.

### BRIEF DESCRIPTION OF THE FIGURES

Further features of the present invention will become apparent to those skilled in the art to which the present invention relates from reading the following specification with reference to the accompanying drawings, in which:

FIG. 1 is a schematic diagram of an Approach Lighting Subsystem (ALS) for a runway according to an embodiment of the present invention;

FIG. 2 is a schematic diagram of a Runway Lighting Subsystem (RLS) according to another embodiment of the present invention;

FIG. 3A is a side view showing the form factor of a conventional incandescent runway light;

FIG. 3B is a side view showing the form factor of runway edge/end light according to the present invention;

FIGS. 4A and 4B show top and side views respectively of the low-profile runway edge/end light of FIG. 3B;

FIG. 5 is a detailed view of an optical system of the runway edge/end light of FIG. 3B according to an embodiment of the present invention;

FIG. 6 shows the general arrangement of a precision adjustment mechanism (“slipfitter”) on a Medium Approach Lighting System (MALSR) light;

FIGS. 7A, 7B, 8A and 8B show the visible and IR elements of the MALSR of FIG. 6;

FIGS. 9A, 9B, 9C and 9D show the general arrangement of a mechanism providing precision angular alignment of a runway end identifier light (REIL) system;

FIGS. 10A and 10B provide details of the optical system of the REIL of FIGS. 9A-9D, showing the preferred aiming angles to produce the required beam pattern, and the visible and infrared elements;

FIG. 11 is a front elevational view of the optical system of the REIL of FIG. 9A-9D;

FIG. 12 shows the arrangement of bits for a lighting control system according to an embodiment of the present invention;

FIGS. 13A and 13B show modulation of a current-controlled power supply output for the control system of FIG. 8; and

FIGS. 14A, 14B show demodulation of a current-controlled power supply output for the control system of FIG. 8.

### DETAILED DESCRIPTION

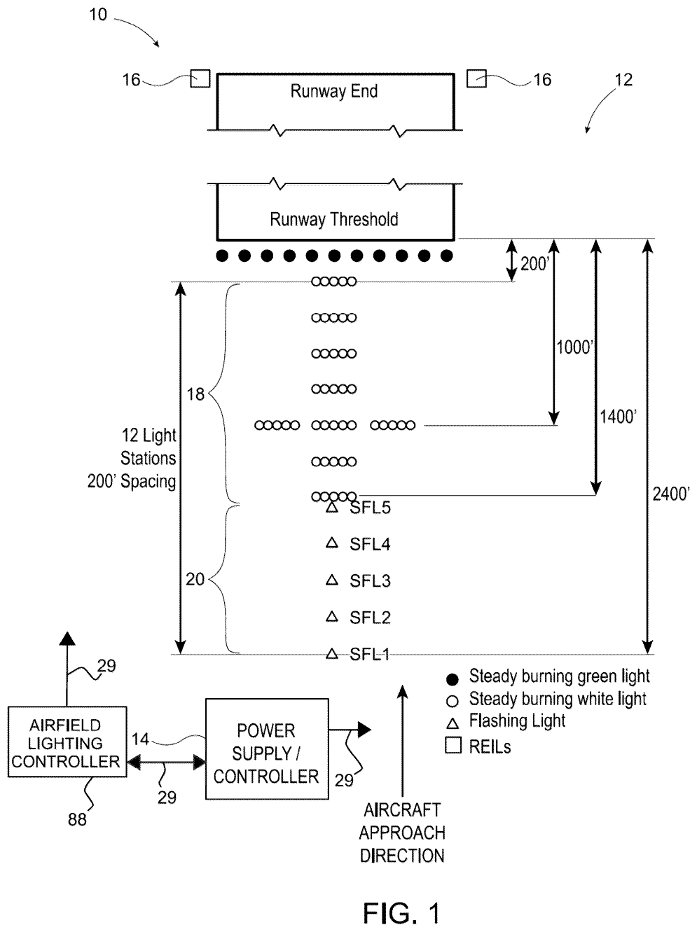

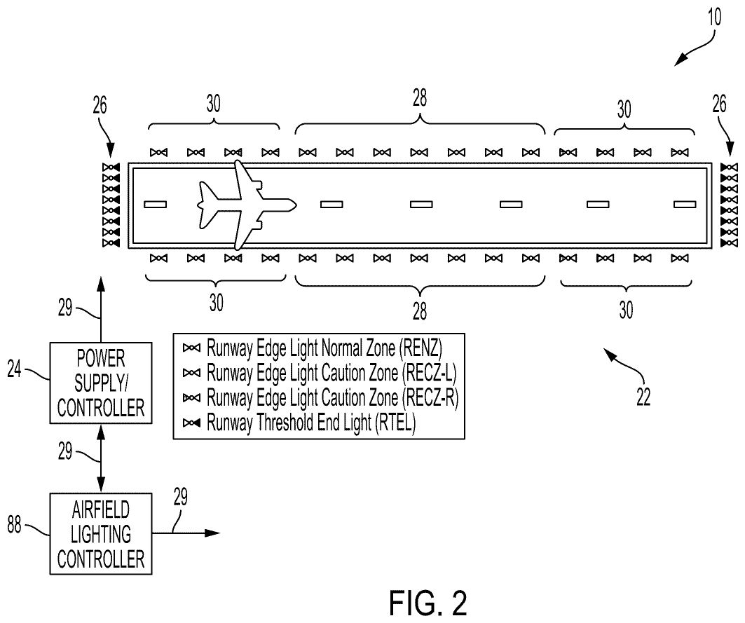

The general arrangement of an airfield lighting system 10 is shown in FIGS. 1 and 2 according to various embodiments of the present invention. Airfield lighting system 10 includes two subsystems. The first subsystem, shown in FIG. 1, is an approach lighting subsystem (ALS) 12 having an ALS power supply/controller 14 (interchangeably termed “constant current regulator 14” or “CCR 14” herein), a set of runway end identifier lights (REIL) 16, medium intensity approach light system with runway alignment indicator lights (MALSR) 18, and sequence flashing lights (SFL) 20. The second subsystem, shown in FIG. 2, is a runway lighting subsystem (RLS) 22 having an RLS power supply/controller 24 (which is similar in function and features to ALS power supply/controller 14 and is likewise interchangeably termed “constant current regulator 24” or “CCR 24” herein) and low-profile lights, including threshold and end lights 26, runway edge lights 28, and runway edge caution zone lights 30. A set of electrical wiring 29 (shown generally, for clarity) connects approach lighting subsystem 12 and runway lighting subsystem 14 to power supply/controllers 14, 24.

Electrical wiring 29 may be power wiring through which commands are also transmitted, as detailed further below. Alternately, electrical wiring 29 may comprise separate interconnecting power and control cables extending between elements of system 10. Electrical wiring 29 may optionally be placed above-ground for expediency during setup or teardown of system 10, which is advantageous if the system is portable.

Preferably, threshold end lights 26 include green and red-light emitters aimed in opposing directions with the red-colored emitters facing the end of the runway. Similarly, runway edge caution zone lights 30 on the left and right sides of the runway preferably include white and yellow light emitters aimed in opposing directions, with the yellow light emitters facing an aircraft as it approaches the end of the runway, which is marked by the red light from threshold end lights 26. Runway edge lights 28 preferably include white light emitters aimed in opposing directions. Other colors for these lights are envisioned within the scope of the invention.

With regard to FIG. 1, it should be noted that the figure depicts single a direction or end of a runway. It will be understood by those skilled in the art that the approach lighting subsystem may be duplicated at the opposite end of the runway, allowing aircraft to land from either direction on the runway.

Lighting system 10 preferably includes infrared (IR) emitters for use in conjunction with night vision devices and other Enhanced Vision Flight Systems (EVFS). The IR lighting levels of the airfield lights are preferably significantly lower than specified by the Federal Aviation Administration (FAA) for civil aircraft usage. This is because experience has shown that existing Federal Aviation Administration (FAA) airfield lighting requirements call for too much infrared energy for covert operations. In addition, unlike FAA-specification systems, the beam pattern of the IR and visible-light portions of each light of system 10 are generally the same.

The sequence flashing lights (SFLs) 20, depicted as triangles in FIG. 1, utilize a novel triggering methodology without additional wiring for “rabbit” function of five (5) SFL Lights. When the ALS Power Supply/Controller control 14's switches enable the SFL feature, a Current Shift Keyed (CSK) communication protocol (described below) communicates with the SFL array 20 to begin the sequence flashing operation. Each of the SFL array 20 lights are individually configured (via internal dip-switches) as SFL #1 thru #5 depending on their location in the SFL array. SFL's sequence from furthest from the end of the runway to closest to the runway, SFL #1 is the outer-most device and SFL #5 is the closest device. The intensity of the Visible and IR light sources are controlled independently by their respective controls. The nominal flash sequence rate is 2 Hz, or 500 mS per sequence flash. Each SFL in the array 20 is preferably on for a period of 100 mS. Once the SFL command (trigger) signal (generated by the CCR 14) is received by the SFLs, each SFL in the array 20 preferably delays its flash according to its position (#1 thru #5) in the array, with #1 have no delay (0 ms), and #5 having a 400 ms delay, with each light preferably remaining on for 100 mS.

The airfield lighting system 10 preferably utilizes light emitting diode (LED) light sources including, without limitation, MALSR 18, SFL 20, REIL 26, runway edge lights 28, and runway edge caution zone lights 30. LEDs are robust and consume less power than light sources such as incandescent lamps. However, any suitable light source is within the scope of the invention.

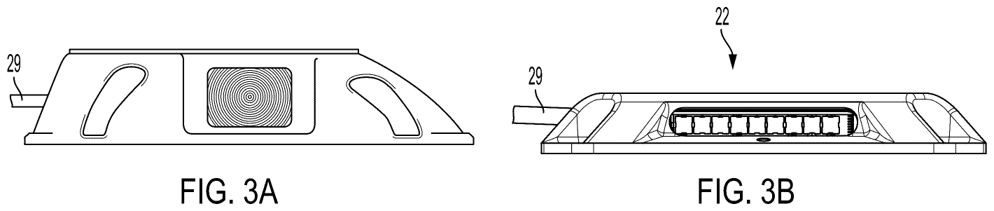

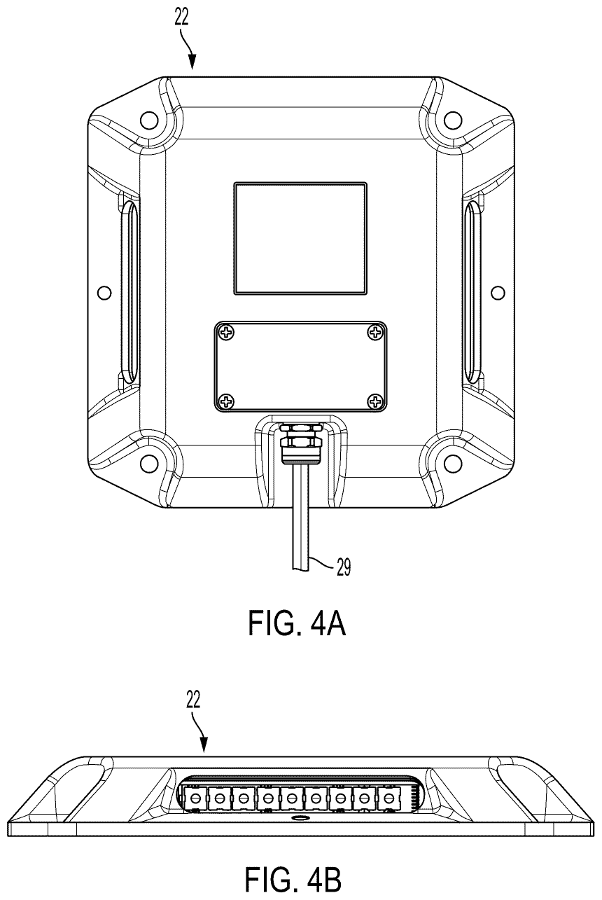

With reference to FIGS. 3A, 3B, 4A and 4B, the package size (i.e., “footprint”) of the RLS 22 low-profile runway edge lights reduced compared to conventional incandescent lights, without a decrease in lighting performance. The reduction in size of the RLS 22 runway lights also does not reduce their physical performance, as the runway lights are designed to survive being run over by ground support vehicles as well as aircraft that stray too close to the runway edge lights. The maximum design load limit for the RLS 22 runway edge lights is preferably about 45,000 lbs. (or about 450 lbs/in²). Preferably, both the height and diameter of the lights is reduced. It should also be noted that the conventional (i.e., legacy) lights use incandescent lamps and do not include overt and covert operational modes.

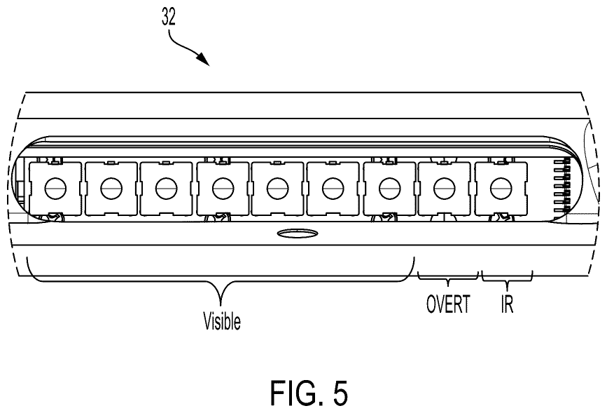

The low-profile runway edge lights also include visible and IR light emitters while maintaining a reduced package size in comparison with conventional lights. The size of an optical system 32, shown in FIG. 5, was minimized to achieve a small-size optical system. The optical system 32 may be selectably controlled to emit visible-only lighting (visible mode), visible and IR lighting (overt mode), or IR-only (covert mode) light emissions.

The present invention provides integrated control of the visible/overt/covert modes and light intensities without the need for wiring in addition to power wiring. The power supplies 14, 24 utilize Current Shift Keyed (CSK) communication to send control “commands” such as light visible/overt/covert operating mode, light intensity, sequencing, and built-in test commands the individual lights over the power cable. CSK communications allows for a robust, error-proof scheme, able to cover large distances without the need for specialized equipment, and the use of a single conductor cable.

The portable airfield may include power management features. For example, heater elements may be installed in the lights for cold-weather operation. The system may also regulate or reduce heater power when operating at high output levels (where the power dissipation of the circuit provides adequate internal heating, eliminating the need for additional heating as provided by the heater element) to minimize power. This allows for an overall reduction in the amount of power required to be generated by the constant current regular (CCR) power supply (14, 24) used to power the airfield lighting system 10 or, in other words, reducing the power consumption of the airfield lighting system. As a result, the required lighting levels are achieved without sacrificing the lighting system's performance in adverse environmental conditions such as cold temperatures. and also environmental were not sacrificed. By not driving high heater power in conjunction with high light output settings the CCR can draw less power, allowing the entire ALS or RLS configurations 12, 22 respectively to operate from a single power supply (CCR).

The ALS CCR 24 may be a two-channel power supply to allow ALS system 12 to be configured to operate from each end of runway (landing direction) from a single power supply. Referring again to FIG. 1, a typical configuration of the MALSR/SFL/REIL system may be installed on each end of the runway, allowing aircraft to approach from either direction. A complete ALS system (as shown in FIG. 1, less power supply) is duplicated at each end of the runway. By providing two switchable power supply channels, the MALSR/REIL/SFL system can be switched to provide guidance from either approach direction from a single power supply 14.

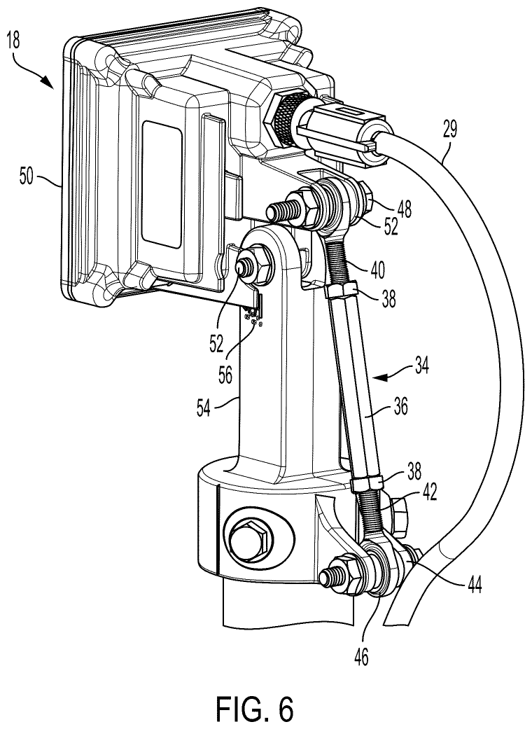

A precision adjustment mechanism 34 on a MALSR 18 light is shown in FIG. 6. A lockable adjustment turnbuckle 36 provides precision elevation adjustment. By loosening a pair of locking nuts 38 at either end, turnbuckle 36 may be rotated, which extends or contracts a set of threaded rods 40, 42. Threaded rod 40 is a reverse-thread while threaded rod 42 is a standard thread. A lower end 44 is terminated at a fixed point 46. An upper end 48 is attached to a MALSR head 50, allowing it to rotate vertically on a pivot point 52 where the MALSR head is secured to a slipfitter base 54. Preferably, the turns ratio is about ⅙ of a turn (one face of turnbuckle 36) per 0.5 degree. Preferably, an angular scale 56 proximate the slipfitter pivot point 52 shows vertical aiming angles, such as in 5-degree increments, from 0 to 25 degrees. Once the desired aiming angle is established, turnbuckle 36 is locked in place by tightening locking nuts 38 against the turnbuckle on its opposing ends.

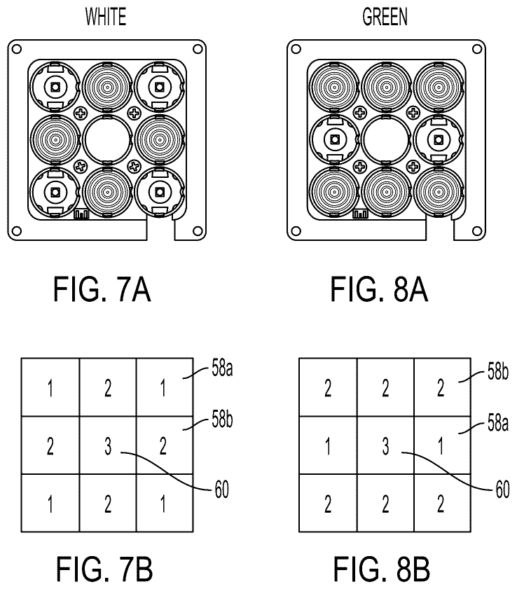

FIGS. 7A, 7B, 8A and 8B show arrays of visible light emitting elements 58 and IR light emitting elements 60 of the MALSR 18 of FIG. 6 and corresponding with (i.e., similar to) the optical system of FIG. 5. FIG. 7A shows the general arrangement of a white-light emitting array, while FIG. 8A shows the general arrangement of a green light emitting array. FIGS. 7B and 8B are diagrams of FIGS. 7A and 8A respectively, showing the arrangement of lighting elements, the squares labeled “1” signifying wide-angle beam visible-light emitting elements 58a, the squares labeled “2” signifying narrow-angle beam visible-light emitting elements 58b, and the squares labeled “3” signifying diffused-beam infrared-light emitting elements 60.

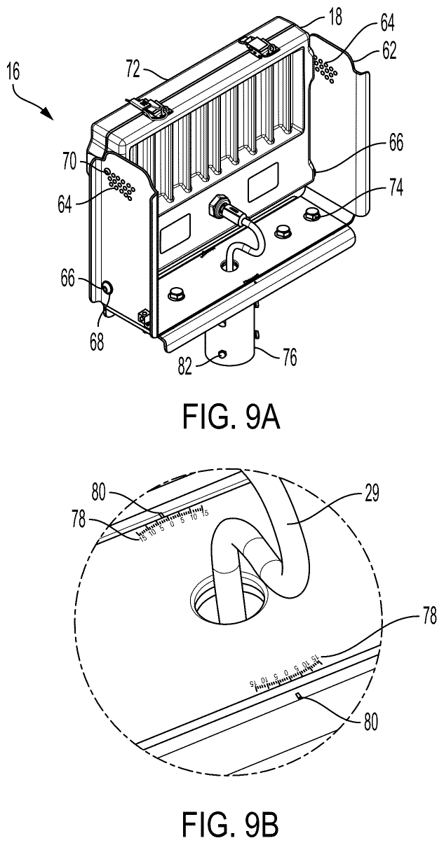

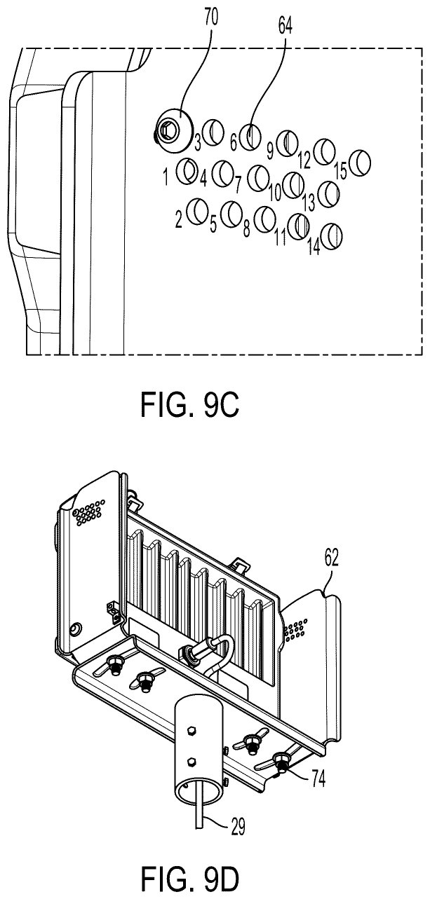

FIGS. 9A-9D show the horizontal & vertical alignment features of the REIL/SFL assembly 16 in both horizontal and vertical axes. On each end of a support base 62 there is an array of apertures 64 that provide vertical aiming, preferably in 1-degree increments from 0 to 15 degrees. A lower connection of base 62 serves as a vertical angular pivot point 66. By loosening a pair of opposing pivot screws 68 and then removing a pair of alignment screws 70 on either side, a REIL/SFL head 72 can be vertically pivoted about the pivot screws and aimed in 1-degree increments.

Similarly, the support rail base 62 also contains adjustments that allow the REIL/SFL head to be aligned horizontally. By loosening a set of horizontal locking screws 74 on the base 62, the entire assembly can be rotationally pivoted on a center mount 76. Preferably, there are markings 78 and a “tic” mark 80 on the base 62 showing alignment from 15 degrees in both left & right directions. Once horizontal locking screws 74 are secured, the unit will maintain the horizontal preset angle. A set of locking screws 82 are used to mount support base 62 to a stationary mounting base (not shown).

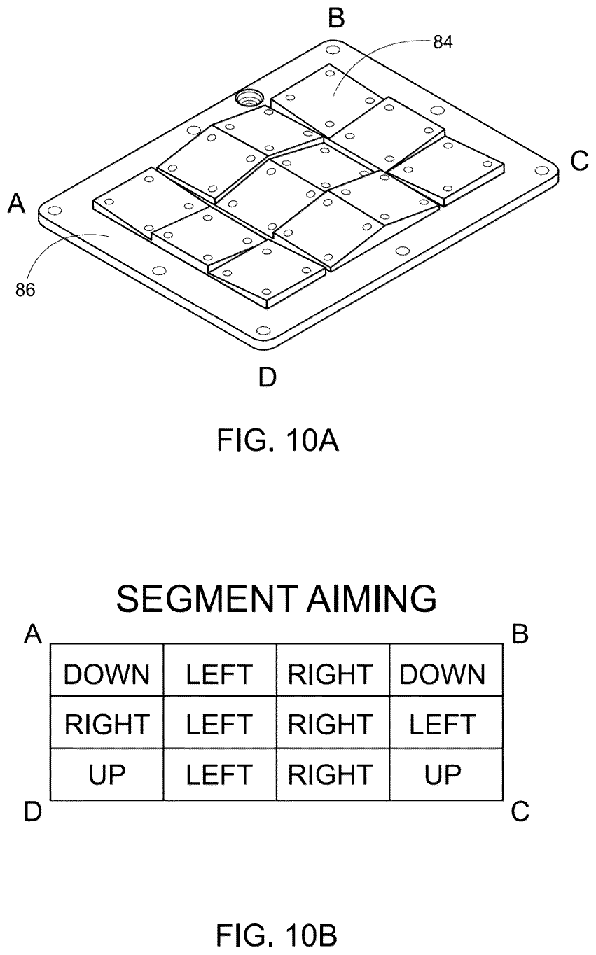

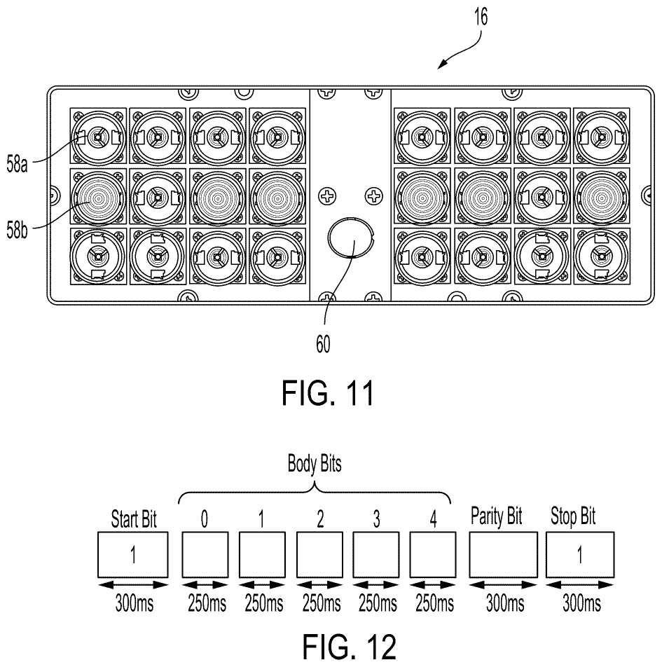

FIGS. 10A and 10B provide details of the optical system of the REIL of FIGS. 9A-9D, showing the aiming angles required to produce the required beam pattern, and the visible and infrared elements, which will correspond to (i.e., are similar to) FIG. 5 (note that there are two of these in each REIL). The corners of the optical system of FIG. 10A and diagram 10B are labeled “A,” “B,” “C,” and “D” to correlate the orientation of the two figures. FIG. 11 is a front elevational view of the optical system of the REIL of FIGS. 9A-9D, with the optical system of FIGS. 10A and 10B. In FIG. 11, the features labeled “1” signify wide-angle beam visible-light emitting elements 58a, the features labeled “2” signify narrow-angle beam visible-light emitting elements 58b, and the features labeled “3” signify diffused-beam infrared-light emitting elements 60. A total of twelve (12) individual LED+OPTIC subassemblies 84 are secured to an LED mount 86 (FIG. 10a) and interconnected with wires (not shown) to complete the electrical circuit. The completed assembly is shown in FIG. 11.

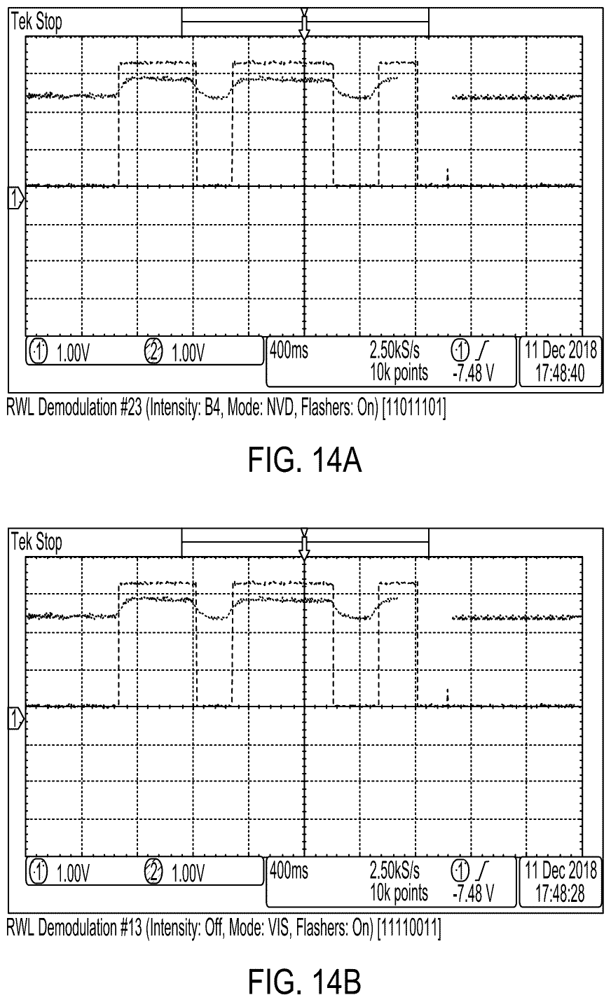

With reference to FIGS. 12, 13A, 13B, 14A, and 14B together, lighting control may be achieved using ASK (amplitude shift keying) and/or CSK communication. The controls are integral to the power supply (CCR 14, 24) and can be used to adjust light intensities without varying input levels. For example, the lights may be dimmed in three or five steps. The control may also selectably change the operating mode of the system between visible, overt and covert operating modes.

In one embodiment the Constant Current Regulator (CCR) power supply 14, 24 (FIGS. 1 and 2) continually operates at a fixed current of 5.50-Amperes. This current corresponds to AC 150/5345-10H, Class 1, Style 1, Current Step (5.5 A) and has an allowable tolerance of 5.40-5.60-Amperes. The chosen operating current is preferably a tradeoff between (a) continually operating midrange through the CCR's output current capability, thus reducing losses due to heat, and (b) allowing a ferro-resonant transformer of CCRs 14, 24 to not operate outside its voltage boundaries under full 4 kW of a load. This current is preferably shifted to 6.50-Amperes during the transmission of a high-bit and back to 5.50-Amperes during transmission of a low-bit. The CSK byte, along with the allotted timing of each bit, is shown in FIG. 8.

The Start and Stop bits are fixed length high-bits; these bits are transmitted at 6.5-Amperes and remain high independent of the message structure. There are five-(5) body bits, allowing for 31 different configurations, in practice, bits can be added or subtracted to tailor any desired number of configurations. The body bits are transmitted at an amplitude dictated by the message. The parity bit can take a value of one-(1) or zero-(0), depending on the parity of the message, all lights and the CCR are on an even-parity scheme. The even-parity scheme is commonly used for error-detection in low baud-rate messages. In an even-parity scheme, if the number of ones-(1) in the message structure is even, the parity bit is set to zero-(0) otherwise if the number of ones-(1) in the message structure is odd, the parity bit is set to one-(1). Finally, a Stop bit of fixed length and high amplitude is transmitted when the message has concluded.

During normal operation of the CCRs 14, 24, a Proportional-Integral-Derivative (PID) loop maintains control of the output current at 5.5-Amperes. When a message is being transmitted, the PID loop parameters are adjusted an order of magnitude higher. The PID adjustment accelerates the output current shift to take place within two-(2) cycles of 60-Hz, or 33.33 milliseconds without overshoots and provide the output waveform within the timing limits of the individual bits.

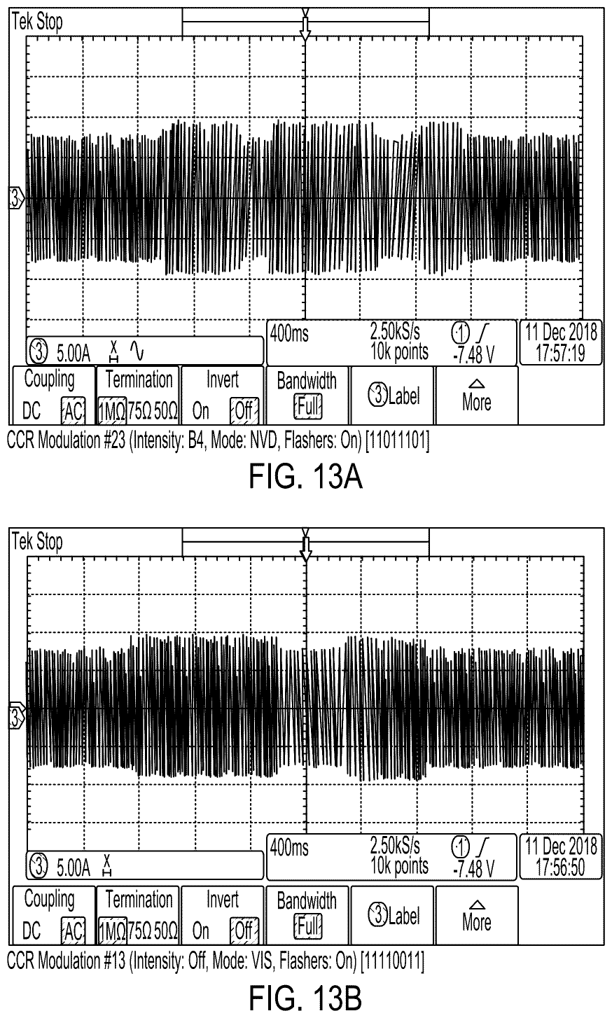

The bit patterns shown in FIGS. 13A and 13B are a representation of the powerline modulation as transmitted by the CCRs 14, 24. Due to the nature of constant current regulation, all light fixtures connected in series with the CCRs will see the same output current across their leads, the CCRs accomplish this by adjusting its output voltage to meet the set output current demand, and this is entirely managed by the ferro-resonant transformer itself. The following waveforms were all acquired with a MALSR Steady Burning/Threshold light and the CCRs operating at 75% capacity of 3 KW.

The light fixtures connected to the CCRs 14, 24 demodulate the powerline CSK message via an RMS-DC converter, long time constant sample-and-hold filter, and a comparator with a low percentage of hysteresis (positive feedback). The demodulated waveforms shown below in FIGS. 10A and 10B correspond to the modulated waveforms shown in FIGS. 9A and 9B respectively. The smaller-height waveform represents the current representation at the RLS 22 level from the output of an RMS-DC converter, the larger-height square wave represents the bit structure as seen after post-processing from the sample-and-hold filter and comparator. The Blue wave is directly fed into the microprocessor of the fixtures and easily decoded into the desired powerline configuration via an enumerated look-up table.

The Constant Current Regulator (CCR) power supplies 14, 24 (FIGS. 1 and 2) provide power and control to the runway lighting subsystems and preferably includes software that is capable of being updated to satisfy functional requirements.

CCRs 14, 24 may be provided as separately-packaged power supplies/controllers. Alternatively, CCRs 14, 24 may be provided in a single package. In yet another embodiment, a single CCR may provide the functions of both CCRs 14 and 24.

CCRs 14, 24 may be packaged to suit a particular installation. Example packages include, without limitation, housings made of metal, plastic and composite materials or combinations thereof. The housings may further include such features as carrying handles, waterproofing seals, tamper-resistant hardware, and locking devices to deter unauthorized access. In various embodiments power supplies 14, 24 may be enclosed in commercially available “off-the-shelf” housings or custom-fabricated housings.

As currently configured, communication between the CCRs 14, 24 and the associated lights is unidirectional. However, bidirectional communication between CCRs 14, 24 and the associated lights is envisioned within the scope of the invention. Such bidirectional communication will allow for CCRs 14, 24 to receive acknowledgments from the lights connected thereto of commands issued by the CCRs. An additional feature of bidirectional communication is the ability to have individually addressable control of lights in system 10. Yet another feature is built-in-test (BIT) and health status reporting of individual lights to CCRs 14, 24.

RLS 22 currently offers OVERT (combination Covert and Visible) functionality. The visible lighting level is preferably extremely low, providing non-vision-enhanced operators (e.g., pilots & ground crew) some visible light to function. This capability may optionally be added to MALSR 18 and REIL/SFL system(s) 16, 20 with minor electronic and software changes thereto.

Both MALSR 18 and REIL 16 have specific aiming requirements and provides the mechanisms described above to set and selectably lock them into position once aimed. In the event of tampering or other disturbances (e.g., being “bumped” by a ground support vehicle) the aiming of the devices could become misaligned. In some embodiments these lights may include an angle sensor (not shown) that will trigger an alert if the misalignment of the associated light exceeds a predetermined limit. The alert may be communicated back to the CCRs 14, 24 using the aforementioned bidirectional communication capability. The sizes of the housings of MALSR 18 and REIL 16 may be changed in shape or increased in size to accommodate this feature.

The number of lights in airfield lighting system 10 is not fixed and may be varied as desired for a particular installation. For example, the number of REIL lights 16, MALSR lights 18, sequence flashing lights 20, threshold end lights 26, runway edge lights 28, and runway edge caution zone lights 30 may be increased or decreased to accommodate runways of larger or smaller width and length.

In some embodiments of the present invention airfield lighting system 10 may be installed at an airfield having an airfield lighting controller 88 (FIGS. 1, 2) that may be used for controlling lights on the airfield. Optionally, power supplies/controllers 14, 24 may be connected to airfield lighting controller 88, allowing airfield lighting system 10 to be at least partially controlled by the airfield lighting controller. As non-limiting examples, airfield lighting controller 88 may communicate with power supplies/controllers 14, 24 to control airfield lighting system 10 to turn lights on or off, change intensity, and change operating mode.

In a further example, a pilot-controlled lighting (PCL) feature of airfield lighting controller 88 may act to turn on airfield lighting system 10 and change its lighting intensity. A pilot approaching to land at the airfield is thus able to remotely and wirelessly turn airfield lighting system 10 on, such as by activating a communications radio in a predetermined manner on a predetermined frequency.

Airfield lighting system 10 may be connected to airfield lighting controller 88 by wired or wireless means, and may use any suitable communications or command architecture, including but not limited to, the command protocols disclosed above, parallel control lines, and serial data buses using standard or proprietary data protocols.

From the above description of the invention, those skilled in the art will perceive improvements, changes, and modifications in the invention. Such improvements, changes, and modifications within the skill of the art are intended to be covered. As a non-limiting example, any dimensions provided herein are for example only and are not intended to be limiting.

1. An airfield lighting system, comprising:
an approach lighting subsystem;
a runway lighting subsystem;
a power supply/controller configured to provide electrical power to the approach lighting subsystem and the runway lighting subsystem, the power supply/controller being further configured to control operation of the approach lighting subsystem and the runway lighting subsystem; and
a set of electrical wiring connecting the approach lighting subsystem and the runway lighting subsystem to the power supply/controller,
wherein the power supply/controller communicates with the approach lighting subsystem and the runway lighting subsystem through the electrical wiring.

2. The airfield lighting system of claim 1, wherein the power supply/controller communications comprise commands from the power supply/controller to at least one of the approach lighting subsystem and the runway lighting subsystem, the commands including at least one of on and off commands, light intensity commands, operating mode commands, sequence flashing commands, and built-in test commands.

3. The airfield lighting system of claim 2, wherein the communications include commands from the power supply/controller to one or more individual lights of at least one of the approach lighting subsystem and the runway lighting subsystem.

4. The airfield lighting system of claim 1, wherein the power supply/controller communicates with at least one of the approach lighting subsystem and the runway lighting subsystem using current shift keying.

5. The airfield lighting system of claim 1, wherein the communications between the power supply/controller and at least one of the approach lighting subsystem and the runway lighting subsystem are bidirectional.

6. The airfield lighting system of claim 5, wherein one or more of lights in at least one of the approach lighting subsystem and the runway lighting subsystem report health status of the lights to the power supply/controller.

7. The airfield lighting system of claim 1, wherein at least one of the approach lighting subsystem and the runway lighting subsystem include at least one of visible and infrared light emitters.

8. The airfield lighting system of claim 7, wherein the light emitters further comprise at least one of wide-angle beam visible light emitters, narrow-angle beam visible light emitters and diffused-beam infrared light emitters.

9. The airfield lighting system of claim 7, wherein at least one of the approach lighting subsystem and the runway lighting subsystem include at least one selectable operating mode, a first operating mode emitting only visible light, a second operating mode emitting only infrared light, and a third operating mode emitting both visible and infrared light.

10. The airfield lighting system of claim 1, wherein at least one of the approach lighting subsystem and the runway lighting subsystem include heater elements, the power supply/controller being configured to regulate and reduce power consumed by the heater elements during predetermined operating conditions of the airfield lighting system to minimize power consumption of the airfield lighting system.

11. The airfield lighting system of claim 1, wherein the power supply/controller comprises a first and a second power supply/controller, the first power supply/controller being coupled to the approach lighting subsystem and the second power supply/controller being coupled to the runway lighting subsystem.

12. The airfield lighting system of claim 11, wherein:
the airfield lighting system is installed proximate a runway; and
the first power supply/controller is configured with two channels, a first channel being configured to selectably operate the approach lighting subsystem at a first end of the runway and a second channel being configured to selectably operate the approach lighting subsystem at a second end of the runway.

13. The airfield lighting system of claim 1, wherein the approach lighting subsystem comprises at least one of:
a plurality of runway end identifier lights;
a plurality of medium intensity approach lights; and
a plurality of sequence flashing lights, and
wherein the runway lighting subsystem comprises at least one of:
a plurality of threshold and end lights;
a plurality of runway edge lights; and
a plurality of runway edge caution zone lights.

14. The airfield lighting system of claim 13, wherein at least one of the runway end identifier lights and the sequence flashing lights are adjustable about a horizontal axis and a vertical axis.

15. The airfield lighting system of claim 13, wherein the medium intensity approach lights further include a selectably lockable adjustment turnbuckle for precision elevation adjustment of light emitted by the lights.

16. The airfield lighting system of claim 13, wherein at least one of the runway end identifier lights and the medium intensity approach lights include an angle sensor, the angle sensor triggering an alert when an associated light is misaligned in excess of a predetermined limit.

17-20. (canceled)

21. A lighting subsystem, comprising:
a plurality of portable light fixtures configured for elevation adjustment, each light fixture including at least one light emitting element configured to emit visible and/or infrared (IR) light in one or more operational modes;
a controller configured to control the one or more operational modes and a light intensity of the at least one light emitting element of each light fixture; and
a power supply configured to provide electrical power to each light fixture.

22. The lighting subsystem of claim 21, wherein each light fixture is further configured to report a health status of the light fixture to the controller, or
wherein each light fixture is configured to communicate bidirectionally with the controller.

23. A lighting subsystem, comprising:
a plurality of portable light fixtures configured to be run over by a vehicle, each light fixture including at least one light emitting element configured to emit visible and/or infrared (IR) light in one or more operational modes;
a controller configured to control the one or more operational modes and a light intensity of the at least one light emitting element of each light fixture; and
a power supply configured to provide electrical power to each individual light fixture.

24. The lighting subsystem of claim 23, wherein each light fixture is further configured to report a health status of the light fixture to the controller, or
wherein each light fixture is configured to communicate bidirectionally with the controller.
